(19) United States
(12) Patent Application Publication
(10) Pub. No.: US 2002/0191769 A1
(43) Pub. Date: Dec. 19, 2002

(54) Connection-selection method and telecommunication endpoint device

(75) Inventors: Yann Regis Michel Duponchel, Adliswil (CH); Sean G. Rooney, Zurich (CH)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/164,218

(22) Filed: Jun. 5, 2002

(30) Foreign Application Priority Data
Jun. 5, 2001 (EP) 01810541.1

(51) Int. Cl. H04M 7/00; H04M 3/00

(52) U.S. Cl. 379/219; 379/242

(57) ABSTRACT

A connection-selection method and apparatus operating on an established first connection between a first endpoint device and a second endpoint device. An example embodiment of the method comprises a decision step in which a decision is made in the first endpoint device whether to switch from the first connection to a second connection between the first endpoint device and the second endpoint device. Upon the decision being to switch, an information-exchange step is carried out for exchanging connection information between the first endpoint device and the second endpoint device, enabling the establishment of the second connection. Furthermore a setup step is carried out for establishing the second connection under use of the connection information. The invention further relates to a telecommunication endpoint device that is connectable via a first connection and a second connection to a second endpoint device having a call-controller for handling the first connection to the second endpoint device, and having a protocol-handler.

### FIELD OF THE INVENTION

The invention generally relates to telephonic interconnect systems. More specifically it relates to interconnection of an Internet telephone system with a legacy telephone system.

### BACKGROUND OF THE INVENTION

The term “legacy telephone systems” as used herein refers to circuit-switched systems such as public service telephone networks (PSTN), integrated service data networks (ISDN) and mobile telephony systems.

Internet telephone systems, on the other hand, are packet-switched systems operating under an IP protocol like the standard Internet protocol SIP or another protocol, e.g. according to standard H.323. Such Internet telephone systems are also termed Internet protocol systems or IP systems. Legacy telephone systems and IP systems represent two established telecommunication systems based upon differing basic approaches. However, means or methods to achieve an interchange of communication between such systems are not readily available.

Internet, or more generally Wide-Area Networking, has been growing during the past years, especially with the introduction of cable modems, modems for asymmetrical digital subscriber lines, termed ADSL modems herein, and with the growth of local area networks (LANs). As the use and the capacity of the Internet are improving and as the availability of Internet-capable devices is increasing, there is more bandwidth available and Internet users tend to be continuously connected to the network.

However it is extremely hard, in general, to find the location of an Internet user because his or her location or address may change and because no official or general directories of the type available with legacy telephone systems exist. While many private directories or presence servers are available in the Internet, there is no general possibility to locate the Internet address of a given Internet user. Internet service providers do not register their subscribers and the subscribers themselves have to register to the presence servers, such as the ‘Sametime’ server, accessible under the URL http://www.sametime.com/, the Aol instantmessenger at the URL http://Hwwww.aol.com/aim/home.html or the Microsoft messenger at the URL http://messenger.msn.com. A more generic form of server therefor is any kind of Ldap server.

As a consequence, Internet telephone systems are very rarely used in replacement of legacy telephone systems. Some related problems could be resolved by an Internet-capable device, a computer for example, connected to the telephone line together with the telephone, so that, for example, a fax could be received directly on the computer, or that the memory of the Internet-capable device could archive voice mails, or simply that calls could be answered by using media devices of computers. With the Internet-capable device being connected to a telephone line but using a cable modem, LAN, ADSL or equivalent for the Internet connection, it is possible to divert calls coming from one telephone system to the other one since the same device handles both calls. However, it is not presently known how to seamlessly and continuously divert calls from the legacy telephone system to the Internet telephone system or vice versa.

### SUMMARY OF THE INVENTION

Accordingly, it is an object of the present invention to provide methods and apparatus allowing selection between two connections according to a decision. These two connections can run through different networks but can also run through the same network, which makes sense, if e.g. they have different parameters like quality, transmission rate or the like.

More particularly the methods and devices permit users of both an Internet-based telephone system and a legacy telephone system, to seamlessly and continuously switch to their preferred telephone system to have a call connection running therein. This is advantageous in that the choice of preferred telephone system can be made without knowing a-priori the capabilities of the remote participant. A further advantage is the fact that substantially no modification is necessary in the existing networks to make use of the invention, and that the special capabilities required for interconnection of an IP network and a legacy telephone network could be concentrated in a single endpoint device. The present invention makes it possible for a user to choose between low price communications and high quality communications according to her/his preference. Further, the invention generally requires no changes of existing legacy telephone or IP networks and-contrary to existing interconnection system-requires no servers in the network. The control intelligence can be located in the endpoint device allowing a rapid deployment of the invented method and/or device.

The endpoint device according to the invention is capable of seamless switching between two connections, e.g. in an IP telephone system and a legacy telephone system and may be termed an “intelligent endpoint”. An advantage of the invention that it can be generally be implemented using existing and/or developing technology. As it requires modification only to endpoints, it does not require agreement with third parties or the intervention of standards bodies.

In some embodiments, the method includes a resource-check step by the first endpoint device for checking whether available resources at the second endpoint device allow establishing the second connection. This avoids failure due to missing resources at the second endpoint device. The method may also include a rule-check step by the first endpoint device for checking one or more predetermined rules which define under which condition or conditions the decision is to switch. This rule set may be particularly useful if it is designed as software, i.e. stored in a memory, possibly being suitable for amendment and/or completion. The user of the endpoint device may thereby be provided with a customizable rule set which might contain some pre-loaded rules to enable direct use of the endpoint device.

The method sometimes includes a result-exchange step by the first endpoint device for communicating to the second endpoint device the result of the rule-check step and/or receiving from the second endpoint device a corresponding result. This result exchange serves to check whether both endpoint devices in the connection support the decision to switch the connection, in order to avoid switching when only one of the endpoint devices has come to the decision to switch.

In general, the method gains more flexibility if the endpoint devices can communicate and decide which of the endpoint devices is performing which task in the setup step. Such determination of which endpoint device does what can e.g. consist of a negotiation process in which the endpoint devices negotiate their roles. It can also be predetermined that for instance the endpoint device that initiated the first call also initiates the call for the setup of the second connection. It is also possible to make the role distribution dependent on one or more parameters, like the connection setup price which might differ with respect to which of the endpoint devices initiates the setup of the second connection.

It is advantageous to terminate the former connection in a connection-termination step, after the second connection has been established, since then only one connection is maintained which reduces connection costs and waste of bandwidth.

The method can in an advantageous manner be applied several times, preferably in regular time intervals, in order to ensure that even under changing conditions, the selected connection is the right connection according to the rules in the rule set.

The method proves very useful if it is applied on connections wherein the first connection runs through a first communication network while the second connection runs through a second communication network, because typically different networks have different characteristics which can be utilized as criteria in the rules that lead to the selection of the connection. The users thereby best profit from the advantage of switching.

The invention is still more specifically directed to a connection-selection method operating on an established first connection between a first endpoint device and a second endpoint device. In an example embodiment the method comprises a decision step in which a decision is made in the first endpoint device whether to switch from the first connection to a second connection between the first endpoint device and the second endpoint device. Upon the decision being to switch, an information-exchange step is carried out for exchanging connection information between the first endpoint device and the second endpoint device, enabling establishing the second connection. Furthermore a setup step is carried out for establishing the second connection under use of the connection information.

The invention further relates to a telecommunication endpoint device that is connectable via a first connection and a second connection to a second endpoint device. It comprises a call-controller for handling the first connection to the second endpoint device, and a protocol-handler for applying a protocol via the first connection, serving for making a decision whether to switch from the first connection to the second connection, and upon the decision being to switch, exchanging connection information between the first endpoint device and the second endpoint device, enabling the establishment of the second connection. The call-controller is designed to, upon the decision being to switch, establish the second connection under use of the connection information.

The invention furthermore relates to a computer program product comprising program code means for performing the above described method and a computer program product comprising the program code means stored on a computer-readable medium.

### DESCRIPTION OF THE DRAWINGS

The invention will be illustrated and explained in more detail but without limitation by means of the enclosed drawing in which:

FIG. 1 is a schematic diagram showing two endpoint devices connected over two networks, and

FIG. 2 is a flowchart illustrating the steps of a connection selection method.

The figures are shown for sake of description, but are not shown in real dimensions, nor are the relations between the dimensions shown in a realistic scale.

### DETAILED DESCRIPTION OF THE INVENTION

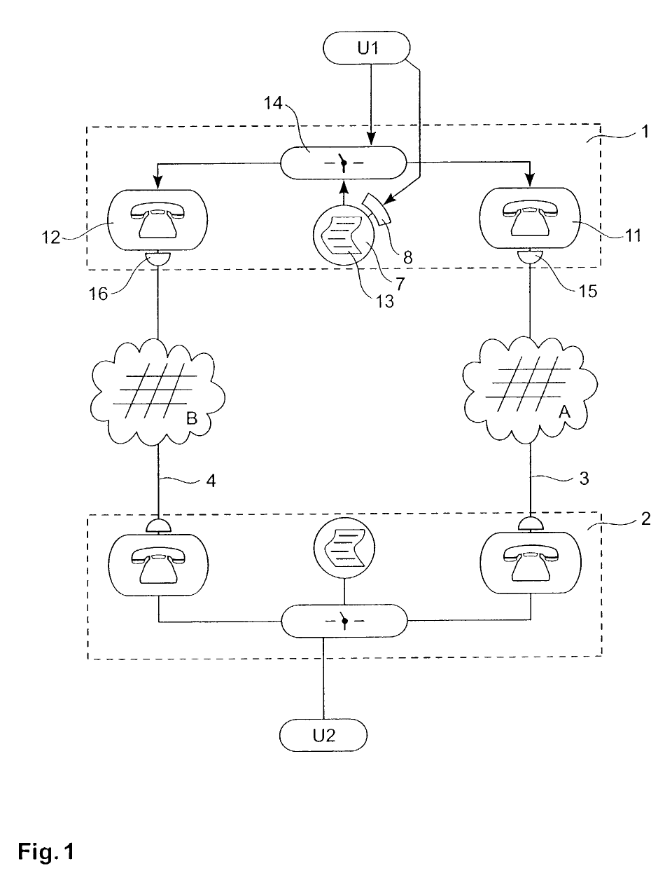

FIG. 1 represents a telecommunication system including as a first communication network A a legacy telephone system, and as a second communication network B an IP telephone system. A first endpoint device 1 and a second endpoint device 2 are both connected to each of the networks A, B. The endpoint device 1 comprises a first call controller 11 connected via a first modem 15 to the first communication network A. It also comprises a second call controller 12 which via a second modem 16, that is here exemplary an ADSL modem or a cable modem, is connected to the second communication network B. A controller switch 14 is arranged between the two controllers 11, 12, having access to a rule set 13 being stored in a memory unit 7. A first user U1 is making use of the first endpoint device 1 by operating one of the controllers 1, 2 via the controller switch 14. The first user U1 has here for his convenience also read-write access to the rule set 13 via an input unit 8. The first call controller 11 provides the functionality of establishing and controlling the first connection 3. Such functionality is in principle known in the prior art and exemplary described in the ITU-T Recommendation Q.1204 (March 1993).

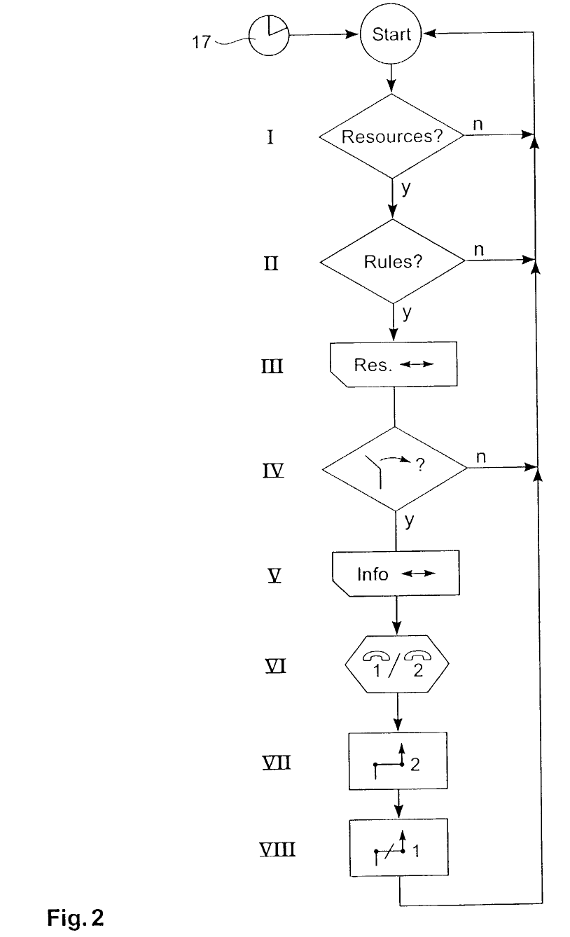

The second endpoint device 2, being operated by a second user U2 is equipped with the same functional units as the first endpoint device 1. The second user U2 initiates from the second endpoint device 2 a call to the first endpoint device 1. The corresponding call setup request signal arrives via the legacy telephony network A at the first modem 15 of the first endpoint device 1. The first modem 15 therefrom creates the corresponding call setup data for the first call controller 11. The first call controller 11 accepts the setup request, typically upon an appropriate action by the first user U 1, and sends a corresponding acceptance signal via the first modem 11 back to the second endpoint device 2. Thereby a voice channel is established between the two endpoint devices 1, 2 as a first connection 3. Once this first connection 3 stands, the controller switch 14 is in charge to perform a connection-selection method which is explained in detail in connection with FIG. 2.

The first endpoint device 1, namely, performs the connection-selection method in order to decide whether the first connection 3 is not better substituted by a second connection 4. Such a decision may be taken for a number of different reasons. For instance, in case of one of the connections 3, 4 running through an IP network, and the other of the connections 3, 4 running through a legacy telephony network, the advantage of the legacy telephony connection lies on the quality side, whereas the advantage of the IP telephony connection is its low cost. This may lead to a situation, where the first connection 3, is established and by the connection-selection method it is found out that for instance for cost-reasons it would be wiser to switch over to the second connection 4. Since there is not necessarily a stable situation, where the once selected connection is the better choice, that method may be performed several times, e.g. in regular time intervals, to ensure that the optimum connection is always selected.

In the following is described the connection-selection method in a case when it is switching from the first connection 3, being here a legacy telephone connection, to the second connection 4, being an IP telephony connection.

The connection-selection method starts with a resource-check step I in which the first endpoint device 1 determines whether the second endpoint device 2 has the resources that are necessary to establish the second connection 4 in the second communication network B. In the case the second communication network B is an IP network, this means that the second endpoint device 2 is connected to the second communication network B and has a valid IP address therein. This resource-check step I can be facilitated in that the second endpoint device 2 sends, e.g. directly after the first connection 3 has been established, its resource information, e.g. its IP address, to the first endpoint device 1, thereby implicitly telling that the second endpoint device 2 is connected to the second communication network B and has a valid IP address therein. For sending, respectively receiving, the resource information the established first connection 3 is utilized. If the resource-check step I returns a positive result, the next step is performed.

The next step to perform is a rule-check step II. Therefor the controller switch 14 accesses the rule set 13 which sets forth the conditions under which a switching from the first connection 3 to the second connection 4 shall be performed. The rules may be manifold. Possible rules may be:

“If the quality of the established first connection 3 is lower than a predetermined value then build up the second connection 4 and switch to it.” The quality can therein be regarded as a whole, or even be divided up into single quality factors to allow even finer defined rules, directed to values of delay, noise, transmittable frequency band, packet loss rate, signal level, transmission rate.

“If the phone call is from a location in another country, then use the second connection 4.”

“If the actual time is later than 18.00, then use the first connection 3.”

“If the calling user is a member of the government, then use the first connection 3.”

Such rules may be technically oriented, and therefore be objectively valuable and therefore be predetermined in the rule set 13. It may however also be envisaged to design the rule set 13 customizable for the respective user U1, U2. Then the user U1, U2 can enter personal rules to complete or substitute the rules of the rule set 13. The rules may be predetermined and fixed but there may also be rules that can be changed by the first user U1. The controller switch 14 can therefor offer an interface to the user U1, allowing him to enter one or more personal rules for deciding when he wants to switch from the established first connection 1 to the second connection 4, thereby applying a rule of the kind:

“If the called user U1 expresses his desire to use the second connection 4, build up the second connection 4 and switch to it.”

In case there are several rules, some prioritizing scheme or scheme for logical combination of the single results is used to come to an overall rule-check result. So after having performed the rule check, the first endpoint device 1 comes to a corresponding result that implies whether the established first connection 3 shall be maintained or whether the second connection 4 shall be built up instead. The rule-check step II is hence a local step which takes place in the first endpoint device 1. The result of that rule-check step II in the first endpoint device 1 is communicated in a result-exchange step III to the second endpoint device 2. The same may be done by the second endpoint device 2 if it has performed a similar rule-check step II. For communicating to the second endpoint device 2 the result of the rule-check and/ or the resource-check, the first endpoint device 1 comprises an input/output port which here is identical to the input/output port of the first endpoint device 1 to the first network A. The next step is a decision-step IV. In the case, the result is by both endpoint devices 1, 2 to switch to the second connection 4, the decision is to do so.

In an information exchange step V, the two endpoint devices 1, 2 exchange the information that is of use for establishing the second connection 4. This step need not be done exactly at that point in time, it can also be done earlier. Typical such information is the IP address of the other endpoint device 1, 2. Again, the first connection 3 is used to perform the information exchange. In principle the exchange need not be bilateral. Depending on how the second connection 4 is built up, it may suffice that only one of the endpoint devices 1, 2 receives the information from the other endpoint device 1, 2.

The next step is a device-selection step VI which serves for determining which of the two endpoint devices 1, 2 is performing which task in building up the second connection 4. This selection mechanism can be set up as a rather simple step in that e.g. the first endpoint device 1 automatically functions as the calling unit, informing the second endpoint device 2 about its role as call recipient. Then follows a setup step VII in which the second connection is eventually established between the two endpoint devices 1, 2. Once that second connection 4 stands, the first connection 3 is terminated in a connection-termination step VIII. This ends this particular embodiment of the connection-selection method.

This method can however be repeated, since, as explained above, the selected connection but also the conditions that are checked in the rule-check step II may not be stable in time and hence at any point in time a different one of the connections 3, 4 may be the better choice. In the decision it may be wise to take into account possible switching costs which hence may influence the decision. An application of the connection-selection method several times in a row, e.g. triggered by a counter 17 could help keeping the decision for the right connection 3, 4 up to date. In the resource-check step I, the rule-check step II, and the decision step IV, if the result is not to switch, the method returns to the start, waiting for the next execution trigger.

The method is the same when switching from an IP telephone system to a legacy telephone system. The method can of course also be performed by exchanging the roles of the first endpoint device 1 and the second endpoint device 2. The method is in principle also executable for multiparty connections involving more than two endpoint devices. The method is then the same and can either imply that the whole set of participating endpoint devices selects the connection as a team, or that single connections between pairs of endpoint devices decide bilaterally upon the connection that lies between them. The data and/or voice transmission channel of the legacy telephone system can here serve as a signaling and controlling channel for setting up the connection in the IP telephone system.

The controller switch 14, is hence a unit that performs the decision process and the switching process in case the decision is to switch. The communication between the first endpoint 1 and the second endpoint 2 is arranged by applying a communication protocol. The protocol serves for making the decision whether to switch from said first connection to said second connection and upon said decision being to switch, exchanging connection information between said first endpoint device and said second endpoint device, enabling establishing said second connection. The controller switch is hence also a protocol handler.

The handling of the media should be transparent to the user: the user should not notice the origin of the media stream (PSTN or IP) and any conflict for resources on the device, such as a speaker, microphone, or similar device is resolved by the endpoint device. The endpoint device could switch media streams when the IP-Telephony call is established or duplicate the media streams for example.

Switching from GSM or ISDN to IP-Telephony can be achieved in the same manner as describe above for switching from PSTN, i.e. legacy telephony, to IP telephony. The main difference resides in the fact that there is a data- and a voice channel in ISDN and GSM. In this case, the endpoint device can use this channel, e.g. the D-Channel on ISDN if the operator allows routing of these messages or by sending SMS messages with a GSM for example, to transmit its capabilities and address to the other participant. The media stream, e.g. the voice channel of ISDN, may no longer be required for sending this information, thereby saving time to setup the connection.

Switching from IP-Telephony to PSTN can be effected in a number of ways, for example, in the same manner as described for switching from PSTN to IP-Telephony. DTMF digits can also be sent out-of-band by using a control channel. With the H.323 protocol, user input messages according to protocol H.245 can be used for this purpose. However, IP-Telephony allows the sending of proprietary information directly on the signaling channel. Accordingly, use can be made of the NonStandardData field of the EndpointType structure that describes the calling endpoint device to transmit the ability of the endpoint device to handle telephone calls coming from the legacy network.

Alternatively, one could also just specify that the endpoint device has several addresses, including some on the legacy telephone network. The H.323 protocol has a special field in the Setup message for defining all the addresses of an endpoint such as IP address, E.I 64 address, or others, and their type. In this an examination of the VendorIdentifier field describing the calling endpoint device suffices to know how to interpret the addresses.

While it can be expected that voice traffic will be effected by way of IP-telephony, it is to be expected that legacy systems, notably those using E.164 addressing and SS7, signal encoding will remain and coexist with IP telephony for the foreseeable future. Voice over IP (VoIP) requires not only the development and deployment of an infrastructure to support VoIP directory services, signaling systems etc., but in order to entirely replace the legacy telephone systems, the IP network would have to be able of supporting a high service quality.

While the invention has been illustrated above by way of specific embodiments it is to be emphasized that this is intended merely as illustration. Thus, the scope of the present invention is to be construed on the basis of the annexed claims. It is obvious for the person skilled in the art that the present invention can be realized in hardware, software, or a combination of these. Also, it can be implemented in a centralized fashion on one single computer system, or in a distributed fashion where different elements are spread across several interconnected computers or computer systems, whereby any kind of a computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

Any disclosed embodiment may be combined in part or as a whole with one or several of the other embodiments shown and/or described. This is also possible for one or more features of the embodiments. It is obvious that a person skilled in the art can modify the shown arrangements in many ways without departing from the gist of the invention which is encompassed by the subsequent claims.

What is claimed is:

1. A connection-selection method operating on an established first connection between a first endpoint device and a second endpoint device, comprising
a) a decision step in which a decision is made in said first endpoint device whether to switch from said first connection to a second connection between said first endpoint device and said second endpoint device,
b) and upon said decision being to switch,
b1) an information-exchange step for exchanging connection information between said first endpoint device and said second endpoint device, enabling establishing said second connection, and
b2) a setup step for establishing said second connection under use of said connection information.

2. A connection-selection method according to claim 1, further comprising a resource-check step by said first endpoint device for checking whether available resources at said second endpoint device allow establishing said second connection.

3. A connection-selection method according to claim 1, further comprising a rule-check step by said first endpoint device for checking at least one predetermined rules which define under which condition or conditions the decision is to switch.

4. A connection-selection method according to claim 3, further comprising a result-exchange step by said first endpoint device for communicating to the second endpoint device the result of the rule-check step and/or receiving from said second endpoint device a corresponding result.

5. A connection-selection method according to claim 3, wherein in the decision-step the result of the rule-check step is used for making said decision.

6. A connection-selection method according to claim 1, further comprising a device-selection step in which upon said decision being to switch, it is decided which of the endpoint devices is performing which task in the setup step.

7. A connection-selection method according to claim 1, further comprising a connection-termination step in which said first connection is terminated in case said second connection is established.

8. A connection-selection method according to claim 1, being applied several times.

9. A connection-selection method according to claim 1, wherein said first connection is selected to run through a first communication network while said second connection is selected to run through a second communication network.

10. A telecommunication endpoint apparatus being connectable via a first connection and a second connection to a second endpoint device, comprising
a call-controller for handling said first connection to said second endpoint device,
a protocol-handler for applying a protocol via said first connection, serving for
a) making a decision whether to switch from said first connection to said second connection,
b) upon said decision being to switch, exchanging connection information between said first endpoint device and said second endpoint device, enabling establishing said second connection,
wherein said call-controller is designed to, upon said decision being to switch, establish said second connection under use of said connection information.

11. A telecommunication endpoint device according to claim 10, wherein the protocol-handler is designed to check whether available resources at said second endpoint device allow establishing said second connection.

12. A telecommunication endpoint device according to claim 10, wherein the protocol-handler is designed to check at least one predetermined rule which define under which condition or conditions the decision is to switch.

13. A telecommunication endpoint device according to claim 12, comprising a memory unit for storing said at least one rule.

14. A telecommunication endpoint device according to claim 12, comprising an input unit for receiving said at least one rule.

15. A telecommunication endpoint device according to claim 12, comprising an input/output port for communicating to the second endpoint device the result of the rule check and/or receiving from said second endpoint device a corresponding result.

16. A telecommunication endpoint device according to claim 10, comprising a timer for triggering said decision to be made in regular time intervals.

17. A telecommunication endpoint device according to claim 10, comprising a functionality-checker unit for establishing whether said endpoint device is connected to at least one network, e.g. by checking the existence of a device in physical-layer-1 or higher, according to the OSI reference model.

18. Computer program product comprising program code means for performing a method according to the claim 1.

19. Computer program product, comprising program code means for performing a method according to the claim 1 stored on a computer-readable medium.

20. A telecommunication endpoint device being connectable via a first connection and a second connection to a second endpoint device, comprising a computer program product according to claim 19.

21. A telecommunication endpoint device according to claim 17, wherein the functionality-checker unit checks the existence of a device in physical-layer-1 or higher, according to the OSI reference model.

22. An article of manufacture comprising a computer usable medium having computer readable program code means embodied therein for causing a telephonic system interconnection, the computer readable program code means in said article of manufacture comprising computer readable program code means for causing a computer to effect the steps of claim 1.

23. A computer program product comprising a computer usable medium having computer readable program code means embodied therein for causing telephonic system interconnection, the computer readable program code means in said computer program product comprising computer readable program code means for causing a computer to effect the functions of claim 10.

24. A connection-selection method according to claim 8, wherein said times are in regular time intervals.
